(19) United States
(12) Patent Application Publication
(10) Pub. No.: US 2016/0279625 A1
(43) Pub. Date: Sep. 29, 2016

(54) VACUUM-ASSISTED PROCESS FOR PREPARING AN ION-EXCHANGED ZEOLITE MEMBRANE

(71) Applicants: DOW GLOBAL TECHNOLOGIES LLC, Midland, MI (US); GEORGIA TECH RESEARCH CORPORATION, Atlanta, GA (US)

(72) Inventors: Sankar Nair, Atlanta, GA (US); Seok Jhin Kim, Atlanta, GA (US); Yujun Liu, Pearland, TX (US); John G. Pendergast, Pearland, TX (US); Ravindra S. Dixit, Lake Jackson, TX (US); Jason S. Moore, Houston, TX (US)

(21) Appl. No.: 14/890,549

(22) PCT Filed: Apr. 22, 2014
(86) PCT No.: PCT/US14/34891

§ 371 Date: Nov. 11, 2015

Related U.S. Application Data
(60) Provisional application No. 61/820,400, filed on May 7, 2013.

(51) Int. Cl. B01J 35/06; B01D 67/00; B01J 20/28; B01J 29/40; B01J 20/18; B01J 20/30; B01D 71/02; B01D 69/02

(52) U.S. Cl. CPC B01J 35/065; B01D 71/028; B01D 67/0051; B01D 67/0093; B01D 69/02; B01J 29/405; B01J 20/186; B01J 20/3085; B01J 20/28035; B01D 2323/10; B01D 2323/08; B01D 2325/42; B01J 2229/186

(57) ABSTRACT

Effect ion-exchange of an alpha-alumina supported zeolite (e.g. a MFI zeolite, an LTA zeolite or a FAU zeolite) membrane, which process comprises: a) placing the membrane, which has a first surface and a spaced apart second surface, the first and second surfaces defining therebetween the membrane, in an ion exchange apparatus such that the first surface is in contact with an ion exchange solution and the second surface is in contact with a vapor space that is connected to a source of reduced pressure; b) actuating the source of reduced pressure to create a pressure differential between the first and second membrane surfaces of at least 0.4 atmosphere (0.405×10⁵ pascals); and c) maintaining the pressure differential under ion exchange conditions for a period of time sufficient to effect exchange of an ion contained in the ion exchange solution with an ion in the zeolite membrane in an amount that is greater than an amount of ion exchange attained using an apparatus that places the second surface in contact with a liquid solvent that is at a pressure of at least one atmosphere (1.013×10⁵ pascals) and the first surface in contact with the ion exchange solution at a pressure of at least two atmospheres (2.026×10⁵ pascals) so as to establish a pressure differential between the two surfaces of at least one atmosphere (1.013×10⁵ pascals), maintaining the pressure differential for the same period of time, and using the same ion exchange membrane, ion exchange solution and ion exchange temperature, the greater amount of ion exchange yielding an improved ion exchange membrane that a ratio of the ion that entered the membrane from the solution to the ion that left the membrane that is greater than that of the ion exchanged membrane prepared with the second surface in contact with the liquid solvent.

The present application claims the benefit of U.S. Provisional Application No. 61/820,400, filed on May 7, 2013.

This invention relates generally to a process for preparing an ion-exchanged zeolite membrane and more particularly to a process that employs a liquid phase on one side of the membrane at atmospheric pressure or greater and a gas phase on an opposing side of the membrane at subatmospheric pressure.

Zeolite membranes are polycrystalline thin films supported on rigid porous substrates with small mass transport resistance (such as stainless steel, glass plates, and alumina discs and tubes). It is known that the adsorption, diffusion, and catalytic properties of zeolite materials can be controlled by ion-exchange.

Aoki et al. (Micropor. Mesopor. Mater. 39 (2000), pages 485-492) presents a study on ion exchange of a ZSM-5 zeolite membrane with hydrogen (H⁺), sodium (Na⁺), potassium (K⁺), cesium (Cs⁺), calcium (CA²⁺) and barium (BA²⁺) cations using in situ synthesized membranes with a silicon to aluminum ratio (SAR) of 25 and 600 on porous stainless steel supports stirred at 200 revolutions per minute (rpm) in an exchange solution at 95 degrees Celsius (° C.) for two hours.

Tarditi et al. (Separation and Purification Technology 61 (2008), pages 136-147) ion-exchanges ZSM-5 membranes and studies the effects of Cs⁺, Ba²⁺ and strontium (Sr²⁺) cations on membrane performance. For the ion exchange, Tarditi et al. immerses the membranes, synthesized on porous stainless steel tubular supports, in an exchange solution at 80° C. for 24 hours, then washed and dried.

S. Murad et al., in “Ion-exchange of monovalent and bivalent cations with NaA zeolite membranes: a molecular dynamics study”, Molecular Physics: An International Journal at the Interface Between Chemistry and Physics, 102:19-20 (2004), pages 2103-2112) reports molecular simulations for ion exchange between aqueous lithium chloride (LiCl) and calcium chloride (CaCl₂) solutions and NaA zeolite membranes, as representative of ion exchange between monovalent and bivalent cations in supercritical and subcritical electrolyte solutions and the Na⁺ in the zeolite membrane. The simulations employ a system that includes a solution compartment consisting of an aqueous LiCl or CaCl₂ solution separated from a solvent compartment by a membrane of NaA zeolite. To facilitate flow across the membrane, Murad et al. uses a pressure in the solution compartment that is significantly higher than the pressure in the solvent compartment, but does not specify the pressures. Murad et al. notes at page 2107 that, even though the solvent pressure is significantly lower than the solution pressure in the simulations, “the Na+ does not move into the solvent compartment (other than a thin adsorbed layer on the membrane surface)”. See also, S. Murad et al., in “Molecular simulations of ion exchange in NaA zeolite membranes”, Chemical Physics Letters 369 (2003), pages 402-408. From the figures in the Murad et al. papers, it appears that most of the ion exchange occurs near the sides of the membranes.

A desire exists for an increase in the amount of cations replacing protons in the zeolite membrane relative to that attained with such conventional ion-exchange methods.

In some aspects, this invention is an improved ion exchange process that uses a zeolite membrane as an ion exchange substrate, especially when the zeolite membrane is supported by, for example, an alpha-alumina support structure, and yields an ion-exchanged membrane that has a greater level or degree of ion exchange, at the same ion exchange temperature and same duration of ion exchange, of an atom (e.g. gallium (Ga) or zinc (Zn)) in an ion exchange solution for an exchangeable atom (e.g. sodium or Na) in the membrane than one can obtain with a conventional ion exchange process such as a) immersion of the membrane in an ion exchange solution or b) a liquid-liquid ion exchange process wherein the ion exchange solution is fed under a pressure in excess of one atmosphere (1.013×10⁵ Pa). By way of contrast, this invention differs from such conventional ion exchange processes in at least two aspects. First, instead of a liquid on both sides of a membrane (a first side in contact with an ion exchange liquid and a second side in contact with a solvent such as water), the process of this invention has a gas or vapor space in contact with the second side of the membrane. Second, rather than immersion in an ion exchange liquid or a pressure-assisted application of ion exchange liquid to the first side, this invention uses an ion exchange liquid at atmospheric pressure on the first side of the membrane and a reduced pressure or vacuum on the second side or vapor space side of the membrane.

In some aspects, this invention is a process for effecting ion-exchange of an alpha-alumina supported zeolite membrane, which process comprises: a) placing the zeolite membrane, the zeolite being selected from MFI zeolites, LTA zeolites and FAU zeolites, which membrane has a first surface and a spaced apart second surface, the first and second surfaces defining therebetween the membrane, in an ion exchange apparatus such that the first surface is in contact with an ion exchange solution and the second surface is in contact with a vapor space that is connected to a source of reduced pressure; b) actuating the source of reduced pressure to create a pressure differential between the first and second membrane surfaces of at least 0.4 atmosphere (0.405×10⁵ pascals (Pa)); and c) maintaining the pressure differential under ion exchange conditions for a period of time sufficient to effect exchange of an ion contained in the ion exchange solution with an ion in the zeolite membrane in an amount that is greater than an amount of ion exchange attained using an apparatus that places the second surface in contact with a liquid solvent that is at a pressure of at least one atmosphere (atm) (1.013×10⁵ Pa) and the first surface in contact with the ion exchange solution at a pressure of at least two atm (2.026×10⁵ Pa) so as to establish a pressure differential between the two surfaces of at least one atm (1.013×10⁵ Pa), maintaining the pressure differential for the same period of time, and using the same ion exchange solution and ion exchange conditions, the greater amount of ion exchange yielding an improved ion exchange membrane with a ratio of the ion that enters the membrane from the solution to the ion that leaves the membrane that is greater than that of the ion exchanged membrane prepared with the second surface in contact with the liquid solvent.

In some aspects, the zeolite membrane used in the above process comprises silicon, aluminum and sodium, with sodium being the ion in the membrane that is exchanged with an ion in the ion exchange solution.

In some aspects, the ion exchange solution used in the above process comprises an aqueous solution of gallium and gallium is the ion from the ion exchange solution that is exchanged with an ion in the membrane.

In some aspects, the ion exchange conditions include a temperature within a range of from 25 degrees centigrade (° C.) to 150° C. (e.g. 70° C.) and a period of time within a range of from six hours (hr) to 49 hr (e.g. 24 hr).

In some aspects, the pressure differential between the first and second membrane surfaces with the second surface being connected to the reduced pressure vapor space is at least 0.4 atm (0.405×10⁵ Pa). In other aspects the pressure differential is at least 0.5 atm, while in other aspects the pressure differential is at least 0.7 atm and in still other aspects the pressure differential is at least one atm (1.013×10⁵ Pa). Skilled artisans recognize that elevation plays a role in determining ambient pressure, with one atm (1.013×10⁵ Pa) being accepted as ambient at sea level and a lower pressure being accepted as ambient at a higher elevation such as one mile (1.61 kilometer (km) in Denver, Colo., USA. Skilled artisans also understand that a pressure differential of more than one atm (1.013×10⁵ Pa) may be obtained by increasing applied pressure to the ion exchange solution in contact with the first membrane surface that is spaced apart from the second membrane surface in contact with the vapor space at reduced pressure.

In some aspects wherein the pressure differential between the first and second membrane surfaces with the second surface being connected to the reduced pressure vapor space is at least one atmosphere (1.013×10⁵ Pa) and the time, temperature, membrane and ion exchange solution are the same, the improved ion exchange membrane prepared by the above process has a ratio of gallium to sodium atoms that is at least two times, in some instances at least five times, and in other instances at least eight times the ratio of gallium to sodium in the ion exchange membrane prepared with the second surface is in contact with a liquid solvent. The magnitude of improvement may vary depending upon either or both of pressure differential and composition of the ion exchange solution with some ions potentially showing a greater magnitude of ion exchange than other ions.

While in principle, one may use any zeolite in membranes of some aspects of this invention, useful zeolites include, but are not limited to, MFI (also called “ZSM-5”), LTA (also called “Zeolite A”) and FAU (also called “Zeolite X” or “Zeolite Y”). Illustrative examples presented below employ zeolite membranes fabricated from MFI zeolite.

Zeolite membrane fabrication is well known to skilled artisans as evidenced by references such as Gascon et al., Chemistry of Materials 24 (2012), pages 2829-2844 and Lew et al., Accounts of Chemical Research 43 (2010), pages 210-219.

### COMPARATIVE EXAMPLE (CEX) A

hydraulic pressure differential (liquid-liquid) of one (1) atmosphere (atm) (1.013×10⁵ pascals (Pa)) gallium ion.

Synthesize a MFI zeolite membrane on a porous α-alumina disk (2.54 centimeter (cm) diameter, 1 millimeter (mm) thickness, 25% by volume (vol %) porosity) by secondary (seeded) growth. Polish one side of the disk with sandpaper before growing the zeolite membrane.

Prepare a MFI seed crystal suspension synthesis solution by dissolving 10 g of fumed silica and 0.7 g of NaOH pellets in 50 ml of aqueous 1 M tetrapropylammonium hydroxide (TPAOH) solution. Heat the seed crystal synthesis solution at 120° C. for 4 hours to prepare a MFI particle slurry. Recover MFI seed particles from the MFI particle slurry via filtration and wash the recovered seed particles in deionized water. Coat MFI seed particles onto the polished side of the disk by dip-coating the disk in an colloidal silicalite suspension containing 0.5 wt % of the silicalite seed particles for 5 seconds. Dry the dip-coated disk in air at a temperature of 60° C. for 24 hours, then calcine the dried disk in air at 550° C. for 6 hours to remove TPAOH from the seed particle pores and yield a seeded alumina disk.

Prepare a synthesis solution for membrane growth by stiffing together 5.65 ml of 1 M TPAOH and 0.161 g of sodium aluminate (NaAlO₂) in 30 ml of deionized water. After 30 min of stiffing the solution, dropwise add 10.2 ml of tetraethyl orthosilicate (TEOS) to the solution under constant stirring. Continue stirring for an additional three (3) hours, then transfer the stirred solution into a Teflon-lined stainless steel autoclave. Vertically place the seeded alumina disk at the bottom of the autoclave so the disk is completely immersed in the synthesis solution. Heat the autoclave contents to a set point temperature of 150° C. for 17 hours, then cease heating and allow the contents of the autoclave to return to ambient temperature (nominally 25° C.) before removing the disk with its MFI membrane layer from the autoclave. Wash the disk with deionized water, then dry and calcine the disk in air at 550° C. for 6 hours to remove TPAOH. Dry the disk and its associated zeolite membrane (also known as “disk-supported zeolite membrane”) at 60° C. in an oven overnight before ion exchange.

The membrane has a nominal silicon to aluminum ratio (SAR) of 25, a silicon atom content of 94.13 atomic percent (AT %), an aluminum atom content of 3.65 AT % and a sodium ion content of 2.23 AT %, each AT % being based upon total number of atoms present in the membrane. Analysis of the membrane via energy-dispersive X-ray spectroscopy (EDXS) shows a SAR of 26 and sodium to aluminum ratio (NAR) of 0.61. Summarize the elemental makeup, the SAR and NAR in Table 1 below.

A high pressure differential (HPD) apparatus has four main parts: a membrane module, a solvent bath, a solution bath, and a water pump. The bell-shaped tube has a bell-shaped opening at one of its ends and a tube-shaped opening at its other end. Attach one face of the disk-supported zeolite membrane to the bell-shaped opening with an epoxy adhesive at the rim of the disk such that the zeolite membrane surface faces into the bell-shaped tube. Connect the tube to a water pump that continuously introduces an ion exchange solution from a solution bath to the membrane surface, nominally the “solution side”, by way of flexible plastic tubing. Install a pressure gauge between the water pump and the plastic tubing and use the pressure gauge to monitor pressure difference between the two membrane sides. Connect the water pump's inlet to a bath containing the ion exchange solution. Split output from the water pump into two flows, one directed to the membrane via the plastic tubing and one directed back to the solution bath. Use the flow back to the solution bath to control feed pressure with a needle valve. The solvent bath is equipped with a reflux condenser and a magnetic stirrer bar. Place the solvent bath on a stirring plate equipped with a temperature controller to maintain constant bath temperature. Immerse the membrane module into the solvent bath so the other side of the disk, nominally the “solvent side”, is fully immersed in deionized water. Before ion exchange, verify water-tightness of the tube-membrane assembly and all connections by pressurizing with deionized water.

Heat both the ion exchange solution, and the deionized water solvent bath, nominally the “solvent side”, to a temperature of 70 degrees centigrade (° C.) and establish, via the water pump, a positive pressure difference of at least one atm (1.013×10⁵ Pa) between the solvent side, which is at ambient pressure (nominally one atm or 1.013×10⁵ Pa at sea level), and the solution side, which is at a higher pressure (e.g. at least two (2) atm (2.026×10⁵ Pa)) when the solvent side is at a pressure of one atm (1.013×10⁵ Pa). In other words, the pressure on the solution side is two (2) atm (2.026×10⁵ Pa). Maintain the temperature and the pressure differential between the solvent side and the solution side of the membrane for a period of twenty four (24) hours to allow ion exchange between the solution and the membrane to occur. After ion exchange, shut the water pump down, remove the membrane from the apparatus, rinse the membrane with deionized water, dry the rinsed membrane in an air oven operating at a set point temperature of 40° C. overnight, then calcine the dried membrane at a temperature of 550° C. for six (6) hours before analysis.

Use EDXS to determine elemental content of the membrane and Ga/Na ratio or GNR and Ga/Si ratio or GSR after ion exchange and summarize the results in Table 1 below.

### CEX B

Liquid immersion of membrane with no pressure differential.

Replicate CEx B, but add stirring of the ion exchange liquid, eliminate the pressure differential and use a membrane having the composition shown in Table 1 below. Summarize results in Table 1 below.

### EXAMPLE (EX) 1

vacuum driven pressure differential (liquid-vapor) of one (1) atm (1.013×10⁵ Pa) with stirring of the ion exchange solution.

A vacuum pressure differential (VPD) apparatus has four main parts a membrane module, a cold trap, a solution bath, and a vacuum pump. Prepare the membrane module as in CEx A, but have the membrane surface facing away from, rather than toward, the bell-shaped tube. Connect the tube-shaped opening of the bell-shaped glass tube to one end of the cold trap through flexible plastic tubing, installing a check valve and a pressure gauge between the vacuum pump and the tubing. Maintain the cold trap at temperature by immersing it in a flask containing liquid nitrogen. Connect the other end of the cold trap to the vacuum pump to establish what is nominally the membrane's “solvent side”. The solution bath, which contains the ion exchange solution, is equipped as the solvent bath is equipped in CEx A with temperature and stirring being controlled and effected as in CEx A. Immerse the membrane module into the ion exchange solution bath so the membrane surface, nominally the “solution side”, is fully immersed into the ion exchange solution bath. Connect the other side of the tube (that not connected to the disk-shaped zeolite membrane) to a vacuum pump, nominally the “solvent side”. Before ion exchange, verify gas tightness of the tube-membrane assembly and all connections. During ion exchange experiments, use the pressure gauge to monitor pressure differential between the two sides of the membrane.

Using the VPD apparatus, heat the ion exchange solution to a temperature of 70° C. and establish, via the vacuum pump, a negative pressure difference between the solution side, which is at atmospheric pressure (one atmosphere or 1.013×10⁵ Pa), and the solvent side which is at an absolute pressure of 0 Pa. Maintain the ion exchange solution temperature and the pressure differential between the solvent side and the solution side of the membrane for a period of twenty four (24) hours to allow ion exchange between the solution and the membrane to occur. Summarize membrane composition before and after ion exchange together with SAR, NAR, GNR and GSR in Table 1 below.

### EX 2

vacuum driven pressure differential (liquid-vapor) of one (1) atm (1.013×10⁵ Pa) without stiffing of the ion exchange solution. Sample 1 from PowerPoint.

Replicate Ex 1, but eliminate stiffing. Summarize membrane composition before and after ion exchange together with SAR, NAR, GNR and GSR in Table 1 below.

TABLE 1

| | EDXS AT % | | | | | | | |
|---|---|---|---|---|---|---|---|---|
| Ex/CEx | Si | Al | Na | Ga | SAR | NAR | GNR | GSR |
| A* | 94.13 | 3.65 | 2.23 | N/A | 26 | 0.61 | N/A | N/A |
| A** | 95.56 | 4.07 | 0.26 | 0.11 | 24 | 0.6 | 0.42 | 0.001 |
| B* | 94.40 | 3.15 | 2.4 | N/A | 30 | 0.78 | N/A | N/A |
| B** | 95.17 | 3.28 | 0.84 | 0.71 | 29 | 0.26 | 0.85 | 0.008 |
| 1* | 94.16 | 3.27 | 2.57 | N/A | 29 | 0.79 | N/A | N/A |
| 1** | 94.95 | 3.74 | 0.24 | 1.07 | 25 | 0.06 | 4.45 | 0.011 |
| 2* | 92.70 | 3.05 | 2.25 | N/A | 30 | 0.74 | N/A | N/A |
| 2** | 95.34 | 3.49 | 0.22 | 0.95 | 27 | 0.06 | 4.32 | 0.010 |

*before ion exchange;
**after ion exchange

The data in Table 1 demonstrate that one unexpectedly achieves a significantly greater degree of ion exchange of gallium ions for sodium ions in an ion exchange membrane when using a vacuum to establish a pressure differential of at least one atm (1.013×10⁵ Pa) in combination with a vapor space on what is nominally the solvent side of a membrane than what one can attain with the same pressure differential established with a positive or relatively greater pressure applied to the solution side of an ion exchange membrane wherein the solvent side is in contact with a liquid at a pressure of one atmosphere (1.013×10⁵ Pa).

### CEX C, EX 3 AND EX 4

Replicate, respectively, CEx A, Ex 1 and Ex 2, but use membranes having the compositions shown in Table 2 below and substitute zinc (as Zn²⁺) for gallium (as Ga³⁺) and summarize results in Table 2 below with Zn, ZNR and ZSR representing, respectively, “zinc”, “zinc to sodium atomic ratio” and “zinc to silicon atomic ratio”.

TABLE 2

| | EDXS AT % | | | | | | | |
|---|---|---|---|---|---|---|---|---|
| Ex/CEx | Si | Al | Na | Zn | SAR | NAR | ZNR | ZSR |
| C* | 94.73 | 3.20 | 2.07 | N/A | 30 | 0.65 | N/A | N/A |
| C** | 96.08 | 3.32 | 0.51 | 0.09 | 27 | 0.15 | 0.18 | 0.001 |
| 3* | 94.57 | 3.18 | 2.25 | N/A | 26 | 0.71 | N/A | N/A |
| 3** | 95.00 | 3.48 | 0.34 | 1.07 | 25 | 0.10 | 3.47 | 0.012 |
| 4* | 94.40 | 3.64 | 1.96 | N/A | 30 | 0.53 | N/A | N/A |
| 4** | 94.89 | 3.85 | 0.31 | 0.95 | 27 | 0.08 | 3.06 | 0.010 |

The data in Table 2 show that Zn performs in a manner similar to Ga when the process of Examples 1-4, sometimes referred to as “vacuum-assisted ion exchange” or, alternately, as “vacuum flow-through technique”, is compared to the process of CEx A through CEx C, more commonly known as “liquid-liquid ion exchange”. The data also show that vacuum-assisted ion exchange leads to a much more extensive ion exchange than the liquid-liquid ion exchange as evidenced by the unexpected differences in ZNR and ZSR of Ex 3 and Ex 4 relative to CEx C.

What is claimed is:

1. A process for effecting ion-exchange of an alpha-alumina supported zeolite membrane, which process comprises: a) placing the alpha-alumina supported zeolite membrane, the zeolite being selected from MFI zeolites, LTA zeolites and FAU zeolites, which membrane has a first surface and a spaced apart second surface, the first and second surfaces defining therebetween the membrane, in an ion exchange apparatus such that the first surface is in contact with an ion exchange solution and the second surface is in contact with a vapor space that is connected to a source of reduced pressure; b) actuating the source of reduced pressure to create a pressure differential between the first and second membrane surfaces of at least 0.4 atmosphere (0.405×10⁵ pascals); and c) maintaining the pressure differential under ion exchange conditions for a period of time sufficient to effect exchange of an ion contained in the ion exchange solution with an ion in the zeolite membrane in an amount that is greater than an amount of ion exchange attained using an apparatus that places the second surface in contact with a liquid solvent that is at a pressure of at least one atmosphere (1.013×10⁵ pascals) and the first surface in contact with the ion exchange solution at a pressure of at least two atmospheres (2.026×10⁵ pascals) so as to establish a pressure differential between the two surfaces of at least one atmosphere (1.013×10⁵ pascals), maintaining the pressure differential for the same period of time, and using the same ion exchange solution and ion exchange membrane, the greater amount of ion exchange yielding an improved ion exchange membrane that a ratio of the ion that entered the membrane from the solution to the ion that left the membrane that is greater than that of the ion exchanged membrane prepared with the second surface in contact with the liquid solvent.

2. The process of claim 1, wherein the zeolite membrane comprises silicon, aluminum and sodium, with sodium being the ion in the membrane that is exchanged with an ion in the ion exchange solution.

3. The process of claim 1 or claim 2, wherein the ion exchange solution comprises an aqueous solution of gallium and gallium is the ion from the ion exchange solution that is exchanged with an ion in the membrane.

4. The process of claim 1 or claim 2, wherein the ion exchange solution comprises an aqueous solution of zinc and zinc is the ion from the ion exchange solution that is exchanged with an ion in the membrane.

5. The process of any of claims 1 through 4, wherein the ion exchange conditions include a temperature within a range of from 25 degrees centigrade to 150 degrees centigrade and a period of time within a range of from six hours to 49 hours.

6. The process of claim 3, wherein the improved ion exchange membrane has a ratio of gallium to sodium atoms that is at least two times the ratio of gallium to sodium in the ion exchange membrane prepared with the second surface is in contact with a liquid solvent.

7. The process of claim 3, wherein the improved ion exchange membrane has a ratio of gallium to sodium atoms that is at least five times the ratio of gallium to sodium in the ion exchange membrane prepared with the second surface is in contact with a liquid solvent.
